(19) United States
(12) Patent Application Publication
(10) Pub. No.: US 2025/0261290 A1
(43) Pub. Date: Aug. 14, 2025

(54) HEATING DEVICE, AND TEMPERATURE ADJUSTING DEVICE PROVIDED WITH SAME

(71) Applicant: ADTEX Inc., Gunma (JP)

(72) Inventors: Hiroshi MUKAIYAMA, Gunma (JP); Hiroo SATO, Gunma (JP)

(21) Appl. No.: 19/113,315

(22) PCT Filed: Sep. 27, 2022
(86) PCT No.: PCT/JP2022/035954

§ 371 Date: Mar. 19, 2025

(51) Int. Cl. H05B 6/38; H05B 1/02

(52) U.S. Cl. CPC H05B 6/38; H05B 1/0233; H05B 2206/022

(57) ABSTRACT

Provided are a heating apparatus and a temperature adjusting apparatus using the heating apparatus. A heating apparatus that heats circulation fluid that adjusts a temperature of a control target includes: a pipe where the circulation fluid flows; a primary coil wound on an outer periphery of the pipe, through which an alternating current flows; and a conductive heating element provided inside an area of the pipe where the primary coil is wound. The heating element generates heat by induction heating with the alternating current in the primary coil, and the heating element heats the circulation fluid.

### TECHNICAL FIELD

The present invention relates to a heating apparatus and a temperature adjusting apparatus including the heating apparatus, and particularly relates to a heating apparatus and a temperature adjusting apparatus including the heating apparatus, which are used to adjust, for example, various manufacturing apparatuses such as a semiconductor manufacturing apparatus and various measuring apparatuses to predetermined temperatures.

### BACKGROUND ART

Generally, it is necessary for, for example, the manufacture of semiconductors to control the temperature of, for example, a manufacturing apparatus in such a manner that the temperature of, for example, a spot on a workpiece to be processed by the manufacturing apparatus or a spot to be measured reaches a predetermined temperature in accordance with the manufacturing process. As an apparatus that performs such temperature control, a temperature adjusting apparatus is conventionally known which includes a circulation path where a heating medium circulates, and cools or heats a control target whose temperature needs to be adjusted by use of the heating medium that circulates along the circulation path. This type of temperature adjusting apparatus includes: for example, a chiller of the vapor-compression refrigeration cycle that cools a circulating heating medium; and, for example, a heating apparatus that heats the cooled heating medium.

For example, Patent Literature 1 discloses a hybrid chiller of an area-based parameter control system that is used to control temperatures of, for example, various apparatuses such as a semiconductor manufacturing apparatus, and processes. The hybrid chiller of the area-based parameter control system disclosed in Patent Literature 1 includes: a circulation fluid circulation circuit that supplies, to a control target, circulation fluid cooled to a predetermined temperature by a refrigeration cycle; and a second circulation fluid circulation circuit that supplies, to the control target, the circulation fluid cooled to a predetermined temperature by a coolant cooled by a cooling tower. A circulation fluid supply path that feeds the circulation fluid to the control target is provided with a heater that heats the circulation fluid.

With such a configuration, the circulation fluid that is supplied to the control target is cooled, properly using a method that cools the circulation fluid by use of the refrigeration cycle and a method that cools the circulation fluid by use of the coolant of the cooling tower. The circulation fluid cooled by the refrigeration cycle or the cooling tower is heated to a predetermined temperature by the heating apparatus such as a heater, and is supplied to the control target.

Moreover, for example, Patent Literature 2 discloses a cooling apparatus including: a first circulation system that circulates a first refrigerant in a condenser back to the condenser through a pump, a heating device, a throttle valve, and a vaporizer; and a second circulation system that includes a heat exchanger placed in the condenser, and circulates a second refrigerant that cools the first refrigerant.

The first circulation system cools a cooling target by use of the latent heat of vaporization of the first refrigerant that boils in the vaporizer. The heating device of the first circulation system is, for example, an electric heater, and heats the first refrigerant in such a manner that the first refrigerant reaches a predetermined temperature. The second circulation system includes a compressor, a second condenser, an expansion valve, and the heat exchanger, and cools and condenses the first refrigerant by use of the latent heat of vaporization of the second refrigerant in the heat exchanger provided in the condenser of the first circulation system.

Moreover, Patent Literature 2 discloses that a second heat exchanger that heats the first refrigerant by condensing the second refrigerant is provided as the heating device of the first circulation system. The second refrigerant of the second circulation system is pressurized by the compressor, is fed to the second heat exchanger, and heats the first refrigerant of the first circulation system.

Moreover, for example, Patent Literature 3 discloses a circulation cooling and heating apparatus that cools and heats circulation fluid to be supplied to a chamber of a plasm etching apparatus, and includes a tank where the circulation fluid is stored, a pump that circulates the circulation fluid between the tank and the chamber, a heat exchanger that exchanges heat between the circulation fluid and a coolant, and a heating means that heats the circulation fluid in the tank. The heating means disclosed in Patent Literature 3 includes a sheathed heater. The circulation fluid is heated by heat generated by the sheathed heater.

### CITATION LIST

### Patent Literature

Patent Literature 1: JP-A-2015-59726

Patent Literature 2: JP-A-2022-20088

Patent Literature 3: JP-A-2014-127534

### SUMMARY OF INVENTION

### Problems to be Solved by Invention

However, the above heating apparatus and temperature adjusting apparatus of the known technologies need some improvements in shortening the time required to adjust temperature and encouraging an increase in efficiency in a production process of, for example, a semiconductor manufacturing apparatus and in reducing the amount of energy consumed to adjust temperature and encouraging energy savings.

Specifically, in, for example, the manufacture of semiconductors, the temperature of a control target such as a manufacturing apparatus may be changed according to, for example, the processing process or measurement process. For example, a temperature setting for the control target may need to be changed to 130° C. after a process where temperature control is performed at a temperature setting of minus 40° C. In such a case, it takes a long time for the temperature adjusting apparatus of the known technology to change the temperature of the control target to a predetermined temperature setting. In this manner, the time required to change the temperature of the control target is the loss of time in the manufacturing process.

In other words, the temperature adjusting apparatus of the known technology needs to heat the circulation fluid with the heating apparatus including an electric heater such as a sheathed heater for a long time to change a temperature setting for a control target and increase the temperature. A process of heating the circulation fluid with, for example, the heating apparatus and increasing the temperature of the control target is performed until the temperature of the control target reaches a stable set temperature. The time required to heat the circulation fluid with, for example, the heating apparatus and increase the temperature of the control target is waiting time during which, for example, a semiconductor manufacturing apparatus cannot perform, for example, a processing process or a measurement process.

Moreover, the heating apparatus, which includes, for example, a sheathed heater, of the known technology has problems that it takes time to change a heating temperature and that accurate temperature adjustment is not easy. In other words, the sheathed heater is constructed by covering a heating element being, for example, a Nichrome wire with an insulator and a metal pipe, and is not configured in such a manner as to transfer the heat of the heating element directly to circulation fluid targeted to be heated. Hence, it takes time from when the amount of heat generated by the heating element is adjusted to when the metal pipe that transfers heat to the circulation fluid is heated to a predetermined temperature. Time is wasted until the temperature of a control target is adjusted to an exact set temperature.

Moreover, the temperature adjusting apparatus of the known technology is configured in such a manner as to cool the circulation fluid with the evaporator of the refrigeration cycle circuit and then heat the cooled circulation fluid to a predetermined temperature with the heating apparatus such as a sheathed heater. Hence, there are problems that, for example, energy that is consumed to heat the circulation fluid, that is, the amount of electric power consumed by, for example, the heating apparatus increases.

In contrast, Patent Literature 2 discloses that the second refrigerant of the second circulation system that cools the first refrigerant of the first circulation system by use of the latent heat of evaporation heats the first refrigerant by use of the latent heat of condensation in the second heat exchanger. In this manner, the first refrigerant corresponding to the circulation fluid to be supplied to the control target is heated by use of the latent heat of condensation of the second refrigerant being the refrigerant of the refrigeration cycle; therefore, the amount of energy consumed by, for example, the sheathed heater that is required to heat the circulation fluid can be reduced.

However, a method that heats circulation fluid by use of the latent heat of condensation of a refrigerant that is condensed by a condenser of a refrigeration cycle circuit as in the cooling apparatus disclosed in Patent Literature 2 has difficulty in heating the circulation fluid to a high temperature. Hence, even when the circulation fluid is heated by use of the latent heat of condensation of the refrigerant, if a temperature setting for a control target is high and it is necessary to heat the circulation fluid to a high temperature, much heating with a heating apparatus such as a sheathed heater is required, and the amount of heating of the heating apparatus cannot be significantly reduced.

Moreover, also in terms of the configuration that uses the condenser of the refrigeration cycle circuit to heat the circulation fluid, if the temperature setting for the control target is changed to significantly increase the temperature of the circulation fluid, it takes time to change the temperature, which leads to the loss of time before the start of, for example, a processing process or a measuring process.

The present invention has been made to solve such problems as described above. An object of the present invention is to provide a heating apparatus and a temperature adjusting apparatus using the heating apparatus, which can efficiently heat circulation fluid with high accuracy and can increase productivity in, for example, the manufacture of semiconductors by shortening the time required to adjust temperature, for example, upon a change in temperature setting. Moreover, another object of the present invention is to provide a temperature adjusting apparatus that can encourage energy savings by reducing the amount of energy consumed in, for example, the manufacture of semiconductors.

### Solution to Problems

A heating apparatus of the present invention is a heating apparatus that heats circulation fluid that adjusts a temperature of a control target, and includes: a conductive pipe where the circulation fluid flows; and a primary coil wound on an outer periphery of the pipe, through which an alternating current flows. The pipe generates heat by induction heating with the alternating current in the primary coil, and the pipe heats the circulation fluid.

Moreover, the heating apparatus of the present invention is a heating apparatus that heats circulation fluid that adjusts a temperature of a control target, and includes: a pipe where the circulation fluid flows; a primary coil wound on an outer periphery of the pipe, through which an alternating current flows; and a conductive heating element provided inside an area of the pipe where the primary coil is wound. The heating element generates heat by induction heating with the alternating current in the primary coil, and the heating element heats the circulation fluid.

Moreover, a temperature adjusting apparatus of the present invention includes: a refrigeration cycle circuit where a compression means, a radiator, a throttle means, and an evaporator are sequentially connected and a refrigerant circulates; and a circulation fluid circuit provided with a circulating pump and a heating apparatus, in which circulation fluid that adjusts a temperature of a control target circulates. The circulation fluid circuit is formed, upstream of the heating apparatus, with a freely openable and closable low-temperature path where the circulation fluid flows through the evaporator in such a manner that heat is exchangeable between the circulation fluid and the refrigerant, the heating apparatus includes: a conductive pipe where the circulation fluid flows; and a primary coil wound on an outer periphery of the pipe, through which an alternating current flows, and the pipe generates heat by induction heating with the alternating current in the primary coil, and the pipe heats the circulation fluid.

Moreover, the temperature adjusting apparatus of the present invention includes: a refrigeration cycle circuit where a compression means, a radiator, a throttle means, and an evaporator are sequentially connected and a refrigerant circulates; and a circulation fluid circuit provided with a circulating pump and a heating apparatus, in which circulation fluid that adjusts a temperature of a control target circulates. The circulation fluid circuit is formed, upstream of the heating apparatus, with a freely openable and closable low-temperature path where the circulation fluid flows through the evaporator in such a manner that heat is exchangeable between the circulation fluid and the refrigerant, the heating apparatus includes: a pipe where the circulation fluid flows; a primary coil wound on an outer periphery of the pipe, through which an alternating current flows; and a conductive heating element provided inside an area of the pipe where the primary coil is wound. The heating element generates heat by induction heating with the alternating current in the primary coil, and the heating element heats the circulation fluid.

### Effects of Invention

A heating apparatus of the present invention includes: a conductive pipe where circulation fluid flows; and a primary coil wound on an outer periphery of the pipe, through which an alternating current flows. The pipe generates heat by induction heating with the alternating current in the primary coil, and the pipe heats the circulation fluid. Consequently, it is possible to transfer the heat of the pipe that generates heat by electromagnetic induction directly to the circulation fluid and efficiently heat the circulation fluid to an exact temperature. Hence, it is possible for, for example, a semiconductor manufacturing apparatus to shorten the time required to heat the circulation fluid for temperature control and execute a highly efficient processing process with little loss of time.

Moreover, the heating apparatus of the present invention may include: a pipe where circulation fluid flows; a primary coil wound on an outer periphery of the pipe, through which an alternating current flows; and a conductive heating element provided inside an area of the pipe where the primary coil is wound. The heating element may generate heat by induction heating with the alternating current in the primary coil, and the heating element may heat the circulation fluid. With such a configuration, it is possible to transfer the heat of the heating element directly to the circulation fluid and efficiently heat the circulation fluid to an exact temperature. Hence, it is possible to reduce the loss of time in a manufacturing process, and increase productivity of, for example, a semiconductor apparatus. Moreover, it is possible to reduce heat dissipation from the heating element directly to the outside of the pipe, and perform highly efficient heating with little radiation heat loss.

Moreover, in the heating apparatus of the present invention, the heating element may be formed of a conductive wire covered with an insulating member and having relative inductivity equal to or greater than one, and the conductive wire may be connected at both ends in such a manner as to configure a conductive closed loop. Consequently, it is possible to cause a large amount of induced current to flow through the conductive wire by highly efficient electromagnetic induction, cause the conductive wire to generate heat, and efficiently heat the circulation fluid to an exact temperature. Moreover, it is possible to reduce flow resistance of the circulation fluid near the heating element and efficiently circulate the circulation fluid.

Moreover, in the heating apparatus of the present invention, the heating element may be a secondary coil wound into a coil, and the secondary coil may configure a conductive closed circuit by connecting both ends of a coil path wound into a coil. Consequently, highly efficient induction heating where an induced current flows suitably through the secondary coil is made possible. Moreover, the flow resistance of the circulation fluid near the heating element is reduced, and the highly efficient circulation of the circulation fluid is achieved.

Moreover, in the heating apparatus of the present invention, the secondary coil may include a portion that is wound in such a manner that a winding diameter of the coil path is different between an upstream side and a downstream side of the pipe. Consequently, it is possible to cause suitable turbulence in the circulation fluid around the secondary coil and promote heat exchange between the heating element and the circulation fluid. Hence, highly efficient heating with the secondary coil allows the circulation fluid to be efficiently adjusted to an exact temperature in a short time.

Moreover, in the heating apparatus of the present invention, the secondary coil may be formed of at least one of an iron-based material, a nickel alloy-based material, or a ferritic stainless steel material. Consequently, it is possible to obtain the secondary coil excellent in durability and safety and increase the efficiency of induction heating of the secondary coil by concentrating an alternating magnetic field of the primary coil to the secondary coil made of a high magnetic material. Hence, the circulation fluid can be efficiently heated.

Moreover, in the heating apparatus of the present invention, the pipe may be formed of an austenitic stainless steel material. Consequently, it is possible to obtain the pipe excellent in corrosion resistance, durability, and safety, and increase the efficiency of induction heating of the secondary coil by concentrating the alternating magnetic field of the primary coil to the secondary coil.

Moreover, in the heating apparatus of the present invention, the pipe may include a bend pipe portion in the area where the primary coil is wound, and the area where the primary coil is wound may be formed in a circular shape, an elliptic shape, or a track shape. Consequently, it is possible to increase magnetic flux density in the pipe by concentrating, in the pipe, magnetic flux generated by the alternating current in the primary coil and to increase the efficiency of induction heating of the secondary coil.

Moreover, a temperature adjusting apparatus of the present invention includes: a refrigeration cycle circuit where a compression means, a radiator, a throttle means, and an evaporator are sequentially connected and a refrigerant circulates; and a circulation fluid circuit provided with a circulating pump and a heating apparatus, in which circulation fluid that adjusts a temperature of a control target circulates. The circulation fluid circuit is formed, upstream of the heating apparatus, with a freely openable and closable low-temperature path where the circulation fluid flows through the evaporator in such a manner that heat is exchangeable between the circulation fluid and the refrigerant, the heating apparatus includes: a conductive pipe where the circulation fluid flows; and a primary coil wound on an outer periphery of the pipe, through which an alternating current flows, and the pipe generates heat by induction heating with the alternating current in the primary coil, and the pipe heats the circulation fluid. With such a configuration, it is possible to cool the circulation fluid flowing in the circulation fluid circuit with the refrigeration cycle circuit, efficiently heat the cooled circulation fluid to an exact temperature with the heating apparatus, and adjust temperature with high accuracy.

Moreover, the temperature adjusting apparatus of the present invention may include: a refrigeration cycle circuit where a compression means, a radiator, a throttle means, and an evaporator are sequentially connected and a refrigerant circulates; and a circulation fluid circuit provided with a circulating pump and a heating apparatus, in which circulation fluid that adjusts a temperature of a control target circulates. The circulation fluid circuit may be formed, upstream of the heating apparatus, with a freely openable and closable low-temperature path where the circulation fluid flows through the evaporator in such a manner that heat is exchangeable between the circulation fluid and the refrigerant, the heating apparatus may include: a pipe where the circulation fluid flows; a primary coil wound on an outer periphery of the pipe, through which an alternating current flows; and a conductive heating element provided inside an area of the pipe where the primary coil is wound. The heating element may generate heat by induction heating with the alternating current in the primary coil, and the heating element may heat the circulation fluid. With such a configuration, it is possible to efficiently heat the circulation fluid cooled in the refrigeration cycle circuit to an exact temperature with the heating apparatus, and supply the circulation water at the suitable temperature to the control target.

Moreover, in the temperature adjusting apparatus of the present invention, the heating element may be formed of a conductive wire covered with an insulating member and having relative inductivity equal to or greater than one, and the conductive wire may be connected at both ends in such a manner as to configure a conductive closed loop. Consequently, it is possible to efficiently heat the circulation fluid to an exact temperature by causing an induced current to efficiently flow through the conductive wire. Moreover, it is possible to reduce the flow resistance of the circulation fluid near the heating element and efficiently circulate the circulation fluid.

Moreover, in the temperature adjusting apparatus of the present invention, the heating element is a secondary coil wound into a coil, and the secondary coil configures a conductive closed circuit by connecting both ends of a coil path wound into a coil.

Consequently, the heating apparatus can perform highly efficient induction heating where an induced current flows suitably. Moreover, it is possible to reduce the flow resistance of the circulation fluid near the heating element in the pipe and efficiently circulate the circulation fluid.

Moreover, in the temperature adjusting apparatus of the present invention, the secondary coil may include a portion that is wound in such a manner that a winding diameter of the coil path is different between an upstream side and a downstream side of the pipe. Consequently, it is possible to cause suitable turbulence in the circulation fluid around the secondary coil and promote heat exchange between the heating element and the circulation fluid. Hence, highly efficient heating with the secondary coil enables efficient and accurate adjustment of the circulation fluid to an exact temperature in a short time.

Moreover, in the temperature adjusting apparatus of the present invention, the pipe may include a bend pipe portion in the area where the primary coil is wound, and the area where the primary coil is wound may be formed in a circular shape, an elliptic shape, or a track shape. Consequently, it is possible to increase magnetic flux density in the pipe by concentrating, in the pipe, magnetic flux generated by the alternating current in the primary coil and increase the efficiency of induction heating of the secondary coil.

Moreover, in the temperature adjusting apparatus of the present invention, the circulation fluid circuit may be formed, upstream of the heating apparatus, with a freely openable and closable high-temperature path where the circulation fluid flows through the radiator in such a manner that heat is exchangeable between the circulation fluid and the refrigerant, the refrigerant may be carbon dioxide, and may heat the circulation fluid under supercritical pressure in the radiator, and the high-temperature path may be provided with a high-temperature tank where the circulation fluid heated by the refrigerant in the radiator is stored. With such a configuration, the temperature adjusting apparatus can adjust temperature with little loss of exhaust heat and with high efficiency by using both of cold heat and hot heat, which are generated in the refrigeration cycle circuit.

Specifically, if the temperature of the circulation fluid returning from the control target is low and the temperature of the circulation fluid needs to be increased sharply, the high-temperature path of the circulation fluid circuit is opened to allow the circulation fluid to flow along the high-temperature path. Consequently, the temperature adjusting apparatus can heat the circulation fluid by use of heat dissipated from the refrigerant flowing through the radiator of the refrigeration cycle circuit. The circulation fluid heated by the radiator of the refrigeration cycle circuit is then heated to a predetermined temperature by the heating apparatus of the circulation fluid circuit, and is supplied at the suitable temperature to the control target in such a manner that the control target reaches an exact set temperature. In this manner, the circulation fluid can be heated by use of the heat dissipation of the radiator of the refrigeration cycle circuit. Therefore, the temperature can be adjusted with high efficiency while the amount of energy to be consumed by the heating apparatus of the circulation fluid circuit is kept low.

Moreover, the refrigerant of the refrigeration cycle circuit is carbon dioxide, and heats the circulation fluid under supercritical pressure in the radiator. Therefore, the circulation fluid can be efficiently heated to a high temperature.

Specifically, the temperature adjusting apparatus of the present invention can heat the circulation fluid, with the radiator of the refrigeration cycle circuit, to a high- temperature region that is not achievable by a condenser of, for example, a chiller of a known technology using an HFC (hydrofluorocarbon)-based refrigerant, an HFO (hydrofluoroolefin)-based refrigerant, or a mixed refrigerant of them. Hence, for example, also if the temperature setting is changed to, for example, as high as 130° C. due to a change in, for example, a processing process, it is possible to increase the temperature of the circulation fluid to a high temperature in a short time. Hence, it is possible to reduce the loss of time caused by temperature adjustment and increase productivity of, for example, a semiconductor apparatus. Moreover, the amount of heating by the heating apparatus of the circulation fluid circuit can be reduced. Therefore, it is possible to reduce the amount of energy consumed by the heating apparatus and encourage energy savings.

Moreover, the high-temperature path is provided with a high-temperature tank where the circulation fluid heated by the refrigerant in the radiator is stored.

Consequently, for example, if a temperature setting for the control target is changed due to a change in, for example, a processing process to significantly increase the temperature of the circulation fluid, the temperature of the circulation fluid that circulates in the circulation fluid circuit can be quickly increased to a predetermined temperature in a short time by supplying, to the circulation fluid circuit, the high-temperature circulation fluid stored in the high-temperature tank. Hence, it is possible to significantly shorten the time required to change the temperature setting and reduce the loss of time accompanied by the change in temperature before the start of, for example, a processing process or a measurement process.

### BRIEF DESCRIPTION OF DRAWINGS

FIG. 1 is a diagram illustrating a temperature adjusting apparatus according to an embodiment of the present invention.

FIG. 2 is a diagram illustrating a heating apparatus of the temperature adjusting apparatus according to the embodiment of the present invention.

FIG. 3 is a diagram illustrating another example of the heating apparatus of the temperature adjusting apparatus according to the embodiment of the present invention.

FIG. 4 is a diagram illustrating another example of the heating apparatus of the temperature adjusting apparatus according to the embodiment of the present invention.

FIG. 5 is a diagram illustrating another example of the heating apparatus of the temperature adjusting apparatus according to the embodiment of the present invention.

FIG. 6 is a diagram illustrating another example of the heating apparatus of the temperature adjusting apparatus according to the embodiment of the present invention.

FIG. 7 is a diagram illustrating a control system of the temperature adjusting apparatus according to the embodiment of the present invention.

FIG. 8 is a diagram illustrating a circulation fluid flow path of the temperature adjusting apparatus according to the embodiment of the present invention.

FIG. 9 is a diagram illustrating a circulation fluid flow path of the temperature adjusting apparatus according to the embodiment of the present invention.

FIG. 10 is a diagram illustrating a circulation fluid flow path of the temperature adjusting apparatus according to the embodiment of the present invention.

FIG. 11 is a diagram illustrating a circulation fluid flow path of the temperature adjusting apparatus according to the embodiment of the present invention.

### DESCRIPTION OF EMBODIMENTS

A temperature adjusting apparatus 1 according to an embodiment of the present invention is described in detail below with appropriate reference to the drawings. Note that illustrated aspects do not limit the present invention, and are merely examples of the embodiment of the present invention.

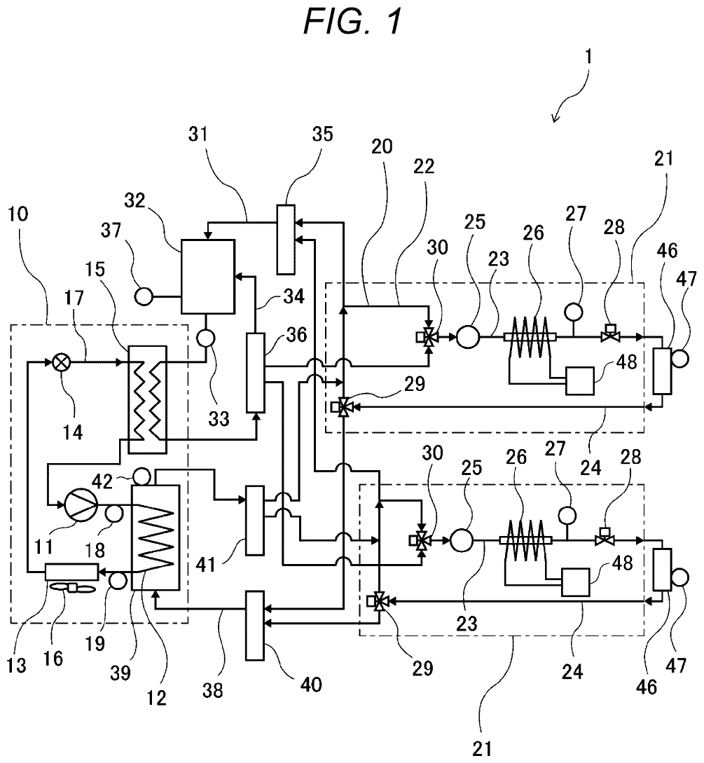

FIG. 1 is a diagram illustrating a schematic configuration of the temperature adjusting apparatus 1 according to the embodiment of the present invention. The temperature adjusting apparatus 1 is an apparatus that is used to adjust a control target 46, for example, various manufacturing apparatuses such as a semiconductor manufacturing apparatus, or various measuring apparatuses used in, for example, semiconductor manufacturing processes, to a predetermined temperature according to the process (refer to FIG. 1).

The temperature adjusting apparatus 1 includes a refrigeration cycle circuit 10 that configures a vapor-compression refrigeration cycle, and cools or heats circulation fluid with a refrigerant, and a circulation fluid circuit 20 that circulate the circulation fluid cooled or heated in the refrigeration cycle circuit 10 in such a manner as to feed the circulation fluid to the control target 46, and adjust the temperature of the control target 46.

Examples of the circulation fluid that circulates in the circulation fluid circuit 20 includes water. The circulation fluid is cooled or heated by the refrigerant of the refrigeration cycle circuit 10, heated to a suitable temperature by a heating apparatus 26 of the circulation fluid circuit 20, and supplied to the control target 46 such as a semiconductor manufacturing apparatus. Consequently, the control target 46 is controlled in such a manner as to be cooled or heated by the circulation fluid adjusted to the suitable temperature and reach a suitable temperature adequate to, for example, each manufacturing process or measurement process.

Firstly, the configuration of the refrigeration cycle circuit 10 is described in detail. The refrigeration cycle circuit 10 is formed by sequentially connecting a compressor 11 as a compression means, a radiator 12, a second radiator 13, an expansion valve 14 as a throttle means, and an evaporator 15 via refrigerant piping 17. The refrigeration cycle circuit 10 configures a closed circuit where the refrigerant is circulated to perform vapor-compression refrigeration cycle operation.

The compressor 11 is a compression means for compressing the refrigerant and feeding the refrigerant to the radiator 12. Compression devices of a rotary type, a scroll type, a reciprocating type, a screw type, and various other types can be adopted as the compressor 11.

Particularly, the compressor 11 of the rotary type is suitable to construct the temperature adjusting apparatus 1 that is made compact with low cooling capacity. Moreover, the compressor 11 may be of a two-stage compression type. The adoption of the two-stage compression type as the compressor 11 is suitable to compress a carbon dioxide refrigerant whose pressure becomes high.

The radiator 12 is a heat exchanger that exchanges heat between the refrigerant that has been compressed to a high pressure and a high temperature by the compressor 11 and the circulation fluid of the circulation fluid circuit 20. The radiator 12 is, for example, a gas cooler. Note that the radiator 12 may be a condenser that condenses the refrigerant. The radiator 12, for example, is provided in a high-temperature tank 39 where the circulation fluid is stored and includes a plurality of tubes where the refrigerant flows although its illustration is omitted. The tubes are, for example, steel tubes.

Specifically, the tubes of the radiator 12 each include an inlet in an upper part thereof and an outlet in a lower part thereof to allow the refrigerant to flow from up to down, are wound into, for example, an approximately spiral shape, and are provided in the high-temperature tank 39. With such a configuration, the refrigerant that flows through the radiator 12 can heat the circulation fluid in the high-temperature tank 39 efficiently. For example, even if the circulation fluid in the high-temperature tank 39 is not supplied to the control target 46, that is, even if the circulation fluid does not flow along a high-temperature path 38 of the circulation fluid circuit 20 provided with the high-temperature tank 39, the refrigerant flowing through the radiator 12 can heat the circulation fluid in the high-temperature tank 39.

In other words, such a configuration allows the radiator 12 to heat the circulation fluid stored in the high-temperature tank 39 to a high temperature without providing, for example, a circulating pump that feeds the circulation fluid to the high-temperature path 38 of the circulation fluid circuit 20 to heat the circulation fluid with the radiator 12.

Hence, when the refrigeration cycle circuit 10 is performing operation in which the circulation fluid is cooled by use of the latent heat of evaporation of the evaporator 15, it is possible to heat the circulation fluid in the high-temperature tank 39 to a high temperature by effectively using exhaust heat from the radiator 12 without circulating the circulation fluid along the high-temperature path 38.

Note that the radiator 12 may be provided outside the high-temperature tank 39 as long as it has a configuration that can exchange heat between the refrigerant and the circulation fluid. For example, heat exchangers of a plate type, a shell-and-tube type, a double-pipe type, and various other types may be adopted as the radiator 12.

The second radiator 13 is a heat exchanger that releases the heat of the refrigerant to the outside, and is provided downstream of the radiator 12. The second radiator 13 is, for example, an air-cooled heat exchanger to which air that exchanges heat with the refrigerant is delivered by an air-blowing fan 16. For example, the second radiator 13 may be a fin-and-tube heat exchanger although its illustration is omitted. In other words, the second radiator 13 includes a plurality of tubes such as steel tubes where the refrigerant flows, and a plurality of aluminum fins provided parallel to each other. The tubes are inserted into holes formed in the fins.

Note that the second radiator 13 may be a water-cooled heat exchanger. Moreover, heat exchangers of a plate type, a shell-and-tube type, a double-pipe type, and various other types can be adopted as the second radiator 13. Particularly, a heat exchanger of the plate type is preferable since the efficiency of heat exchange is high and the second radiator 13 can be made compact.

The second radiator 13 is provided downstream of the radiator 12. Therefore, the refrigerant that has dropped in temperature due to heating of the circulation fluid in the radiator 12 can be cooled to a lower temperature. Moreover, also if the circulation fluid in the high-temperature tank 39 is increased to a high temperature and there is no need to heat the circulation fluid with the refrigerant flowing through the radiator 12, the high-temperature refrigerant that has passed through the radiator 12 can reduce in temperature to a low temperature by heat dissipation of the second radiator 13. Consequently, the cooling capacity of the refrigeration cycle circuit 10, that is, the ability to cool the circulation fluid by use of the latent heat of evaporation of the refrigerant in the evaporator 15, is provided also in a state where the high-temperature tank 39 is filled with the high-temperature circulation fluid.

The expansion valve 14 is a throttle means for decompressing the high-pressure refrigerant that has reached a low temperature after passing through the radiator 12 and the second radiator 13. Moreover, the expansion valve 14 has a function of adjusting the flow of the refrigerant. Throttle means such as an electronic expansion valve, a thermostatic expansion valve, a capillary tube, and various other types can be adopted as the expansion valve 14. If an electronic expansion valve is adopted as the expansion valve 14, the cooling and heating of the circulation fluid in the refrigeration cycle circuit 10 can be controlled with high efficiency.

The evaporator 15 is a heat exchanger that evaporates the low-pressure liquid refrigerant and cools the circulation fluid with the latent heat of evaporation. Heat exchangers of a plate type, a double-pipe type, a tube contact type, a shell-and-tube type, and various other types can be adopted as the evaporator 15.

Particularly, a heat exchanger of the plate type is preferable since the efficiency of heat exchange is high and the evaporator 15 can be made compact. Moreover, the double-pipe type and the tube contact type are excellent in easy manufacturing and processing and easy obtainability of suitable compressive strength.

The refrigerant piping 17 downstream of the evaporator 15 is connected to the compressor 11 via an unillustrated accumulator. With the above configuration, the closed circuit of the refrigeration cycle circuit 10 is formed in which the compressor 11, the radiator 12, the second radiator 13, the expansion valve 14, and the evaporator 15 are sequentially connected.

The refrigerant used in the refrigeration cycle circuit 10 is, for example, carbon dioxide. The carbon dioxide refrigerant heats the circulation fluid under supercritical pressure in the radiator 12 as a gas cooler. Consequently, the circulation fluid can be efficiently heated to a high temperature.

Specifically, the radiator 12 of the refrigeration cycle circuit 10 can heat the circulation fluid to a high-temperature region that is not achievable by a condenser of, for example, a chiller of a known technology using an HFC-based refrigerant, an HFO-based refrigerant, or a mixed refrigerant of them.

For example, the temperature adjusting apparatus 1 can increase the temperature of the circulation fluid to a high temperature in a short time also if, for example, the temperature setting is changed to as high as 130° C. due to a change in, for example, a processing process. Hence, the temperature adjusting apparatus 1 can reduce the loss of time caused by temperature adjustment and increase productivity of, for example, a semiconductor apparatus. Moreover, it is possible to reduce the amount of heating by the heating apparatus 26 of the circulation fluid circuit 20. Therefore, it is possible to reduce the amount of energy consumed by the heating apparatus 26 and encourage energy savings in, for example, the manufacture of semiconductors. Note that the temperature adjusting apparatus 1 may use, for example, an HFC-based refrigerant, an HFO-based refrigerant, or a mixed refrigerant as the refrigerant of the refrigeration cycle circuit 10.

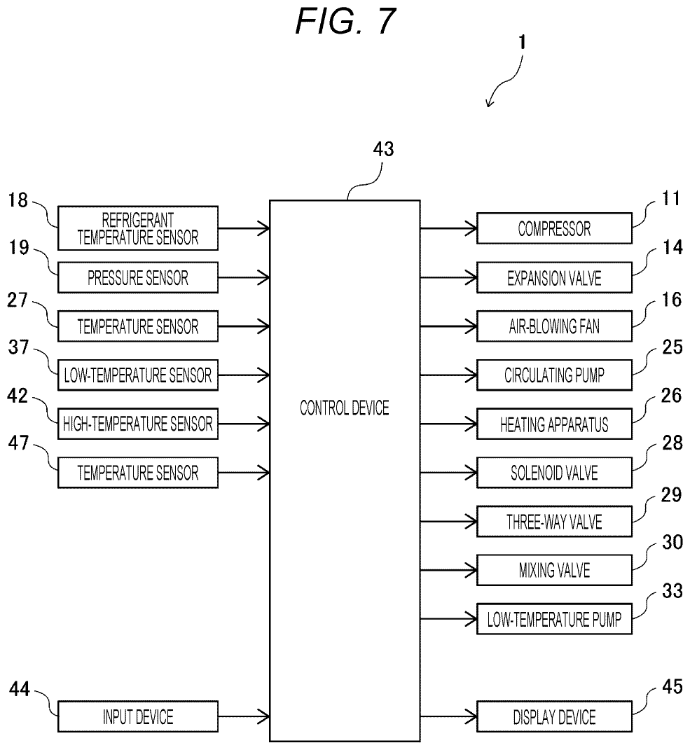

Moreover, the refrigeration cycle circuit 10 is provided with, for example, a refrigerant temperature sensor 18 that measures the temperature of the refrigerant, and a pressure sensor 19 that measures the pressure of the refrigerant. A control device 43 (refer to FIG. 7) controls the number of rotations of the compressor 11 and the degree of opening of the expansion valve 14 on the basis of, for example, the temperature of the refrigerant measured by the refrigerant temperature sensor 18 and the pressure of the refrigerant measured by the pressure sensor 19 in addition to the temperature setting and measured temperature information of the control target 46.

Next, the circulation fluid circuit 20 is described in detail. The circulation fluid circuit 20 configures a closed circuit where the circulation fluid that cools or heats the control target 46 circulates. Specifically, the circulation fluid circuit 20 includes: a plurality of circuit modules 21 that are connected to the control targets 46 and circulate the circulation fluid; a low-temperature path 31 that is connected to the circuit modules 21 and in which the circulation fluid flows through the evaporator 15 in such a manner as to be able to exchange heat with the refrigerant; and the high-temperature path 38 that is connected to the circuit modules 21 and in which the circulation fluid flows through the radiator 12 in such a manner as to be able to exchange heat with the refrigerant.

Each of the circuit modules 21 is a device that supplies the circulation fluid to the control target 46 and adjusts the temperature of the control target 46. The each of the circuit modules 21 is formed with a basic circulation path 22 that is a basic closed circuit that circulates the circulation fluid. Specifically, the each of the circuit modules 21 is formed with the basic circulation path 22 being a closed circuit where a feed path 23 that supplies the circulation fluid to the control target 46 such as a semiconductor manufacturing apparatus, and a return path 24 that returns the circulation fluid that has cooled or heated the control target 46 are connected.

The feed path 23 of the each of the circuit modules 21 is provided with a circulating pump 25 that feeds the circulation fluid to the control target 46, the heating apparatus 26 that heats the circulation fluid to be supplied to the control target 46 and adjusts the temperature, and a temperature sensor 27 that measure the temperature of the circulation fluid heated by the heating apparatus 26.

The heating apparatus 26 is an induction heating type of heating means that heats the circulation fluid. The heating apparatus 26 is described in detail below. The heating apparatus 26 is connected to an induction heating power supply 48.

The induction heating power supply 48 is a power supply device that supplies electric power to the heating apparatus 26. The electric power from the induction heating power supply 48 causes an alternating current to flow through the heating apparatus 26. The circulation fluid is heated by induction heating with the alternating current.

The temperature sensor 27 is provided to the feed path 23 downstream of the heating apparatus 26, and measures the temperature of the circulation fluid heated by the heating apparatus 26. The circulating pump 25, the heating apparatus 26, and the temperature sensor 27 are connected to the control device 43. The control device 43 controls the circulating pump 25 and the heating apparatus 26 in such a manner that the temperature of the circulation fluid measured by the temperature sensor 27 reaches a predetermined temperature. Consequently, the temperature of the control target 46 is controlled to a set temperature. Specifically, the control device 43 controls the output of the induction heating power supply 48, that is, the electric power to be supplied to the heating apparatus 26, and controls the heating of the circulation fluid with the heating apparatus 26.

Moreover, the basic circulation path 22 of the each of the circuit modules 21 is provided with a solenoid valve 28 that opens and closes the feed path 23. Consequently, if the control target 46 connected to the circuit module 21 does not require temperature control, the flow of the circulation fluid can be stopped by closing the solenoid valve 28.

The low-temperature path 31 is a path for the refrigeration cycle circuit 10 to cool the circulation fluid. The low-temperature path 31 is connected on an inlet side thereof to a return path 24 side of the circuit module 21 and on an outlet side thereof to a feed path 23 side of the circuit module 21 in such a manner as to form a bypass path for the circulation fluid in the basic circulation path 22.

In other words, the circulation fluid that circulates along the basic circulation path 22 of the circuit module 21 can flow into the low-temperature path 31 at a branch point being the inlet of the low-temperature path 31. Moreover, the circulation fluid can also flow toward the feed path 23 without flowing into the low-temperature path 31.

A junction of the outlet of the low-temperature path 31 and the basic circulation path 22 is provided with a mixing valve 30. The mixing valve 30 is a valve that mixes the circulation fluid that has passed through the low-temperature path 31 with the circulation fluid to be supplied to the contract target 46 via the feed path 23 of the circuit module 21. In other words, the mixing valve 30 can freely open and close the low-temperature path 31 and freely adjust the flow rate of the low-temperature path 31.

The circulation fluid that has returned from the control target 46 is mixed with the circulation fluid cooled by the evaporation of the refrigerant by the evaporator 15 of the refrigeration cycle circuit 10 on the basis of adjustment by the mixing valve 30. Therefore, operation that achieves a suitable temperature can be performed.

Moreover, it is also possible to perform operation that does not supply the circulation fluid cooled by the evaporator 15 to the control target 46 on the basis of adjustment by the mixing valve 30. In other words, it is also possible to perform temperature adjustment operation in which only the circulation fluid that has returned from the control target 46, or only the circulation fluid heated by the radiator 12, is fed to the feed path 23, heated by the heating apparatus 26, supplied to the control target 46, and circulated.

Moreover, the low-temperature path 31 is provided with a low-temperature tank 32 where the circulation fluid is stored, a low-temperature pump 33 that feeds the circulation fluid, and a low-temperature circulation path 34 that returns the circulation fluid to the inlet side of the low-temperature path 31 without feeding the circulation fluid to the control target 46.

Specifically, for example, the low-temperature tank 32 is provided on the inlet side of the low-temperature path 31. The low-temperature pump 33 is provided downstream of the low-temperature tank 32. The evaporator 15 is provided downstream of the low-temperature pump 33. The low-temperature circulation path 34 may be provided in such a manner as to connect a branch line pipe 36 provided downstream of the evaporator 15 of the low-temperature path 31, and the low-temperature tank 32 provided on the inlet side of the low-temperature path 31.

The low-temperature tank 32 is provided with a low-temperature sensor 37 that measures the temperature of the circulation fluid in the low-temperature tank 32. The low-temperature pump 33 and the low-temperature sensor 37 are connected to the control device 43. The control device 43 may control, for example, operation of the circulating pump 25 and the low-temperature pump 33 and the adjustment of the degree of opening of the mixing valve 30 by using information on the temperature of the circulation fluid measured by the low-temperature sensor 37 to make a computation.

As described above, the low-temperature path 31 is provided with the low-temperature tank 32, the low-temperature pump 33 that feeds the circulation fluid, and the low-temperature circulation path 34 that returns the circulation fluid from the outlet side to the inlet side of the low-temperature path 31. Hence, even if the circulation fluid in the low-temperature path 31 is not used as the circulation fluid to be supplied to the control target 46, the circulation fluid in the low-temperature path 31 can be cooled by the refrigerant flowing through the evaporator 15 by circulating the circulation fluid in the low-temperature path 31.

The circulation fluid cooled by the refrigerant can be stored in the low-temperature tank 32, and the stored low-temperature circulation fluid can be supplied to the circulation fluid circuit 20 if needed. For example, if the temperature setting for the control target 46 is changed due to a change in, for example, a processing process to significantly reduce the temperature of the circulation fluid, the low-temperature circulation fluid stored in the cold tank can be supplied to the circulation fluid circuit 20.

Consequently, the temperature of the circulation fluid that circulates in the circulation fluid circuit 20 can be quickly reduced to a predetermined temperature in a short time. Hence, the time required to change the temperature setting is significantly shortened; therefore, the loss of time accompanied by the change of the temperature before the start of, for example, a processing process or a measurement process can be reduced.

Moreover, as described above, the low-temperature path 31 is provided with the low-temperature tank 32, the low-temperature pump 33, and the low-temperature circulation path 34. Hence, even if the circulation fluid in the low-temperature path 31 is not supplied to the control target 46, it is possible to operate the refrigeration cycle circuit 10 and heat the circulation fluid in the high-temperature path 38 with the refrigerant of the radiator 12.

The high-temperature path 38 is a path for the refrigeration cycle circuit 10 to heat the circulation fluid. The high-temperature path 38 is connected on an inlet side thereof to the return path 24 side of the circuit module 21 and on an outlet side thereof to the feed path 23 side of the circuit module 21 in such a manner as to form a bypass path for the circulation fluid in the basic circulation path 22.

Specifically, the basic circulation path 22 of the circulation fluid circuit 20 is provided with a three-way valve 29 upstream of the branch point to the low-temperature path 31. The three-way valve 29 is a valve that switches between whether or not the circulation fluid returning from the control target 46 is fed to the high-temperature path 38. In other words, the three-way valve 29 can freely open and close the high-temperature path 38 and can freely adjust the flow rate of the high-temperature path 38.

Specifically, the inlet of the high-temperature path 38 is connected to the three-way valve 29. The outlet of the high-temperature path 38 is connected downstream of the three-way valve 29 of the basic circulation path 22 and upstream of the branch point to the low-temperature path 31.

With such a configuration, the switching of the three-way valve 29 allows switching between operation in which the circulation fluid heated by the radiator 12 of the refrigeration cycle circuit 10 is supplied to the control target 46, and operation in which the circulation fluid heated by the radiator 12 of the refrigeration cycle circuit 10 is not supplied to the control target 46, and executing the operation.

The high-temperature path 38 is provided with the high-temperature tank 39 where the circulation fluid heated to a high temperature is stored, and a high-temperature sensor 42 that measures the temperature of the circulation fluid in the high-temperature tank 39. The radiator 12 of the refrigeration cycle circuit 10 is provided in the high-temperature tank 39 in such a manner that the refrigerant can heat the circulation fluid. The high-temperature tank 39 is formed with a circulation fluid inlet in a lower part thereof, and is formed with a circulation fluid outlet in an upper part thereof. Consequently, the high-temperature circulation fluid stored in the high-temperature tank 39 can be efficiently supplied to the control target 46.

In other words, the low-temperature circulation fluid returning from the control target 46 flows into the high-temperature path 38 via the three-way valve 29, and flows into the high-temperature tank 39 through the inlet formed in the lower part of the high-temperature tank 39. The high-temperature circulation fluid stored in the high-temperature tank 39 is fed to the basic circulation path 22 through the outlet formed in the upper part of the high-temperature tank 39, and is supplied to the control target 46.

In this manner, the temperature adjusting apparatus 1 includes the high-temperature tank 39, and can feed the high-temperature circulation fluid stored in the high-temperature tank 39 to the basic circulation path 22. Hence, for example, if the temperature setting for the control target 46 is changed due to a change in, for example, a processing process to significantly increase the temperature of the circulation fluid, the temperature can be changed with high efficiency.

In other words, it is possible to supply the high-temperature circulation fluid stored in the high-temperature tank 39 to the circulation fluid circuit 20 and quickly increase the temperature of the circulation fluid that circulates in the circulation fluid circuit 20 to a predetermined temperature in a short time. Hence, the temperature adjusting apparatus 1 can significantly shorten the time required to change the temperature setting and reduce the loss of time accompanied by the change in temperature before the start of, for example, a processing process or a measurement process.

Note that the control device 43 may use information on the temperature of the circulation fluid in the high-temperature tank 39, the temperature being measured by the high-temperature sensor 42, to perform a computation for opening and closing control over the three-way valve 29. Consequently, the flow in the high-temperature path 38 can be controlled according to the amount of the high-temperature circulation fluid stored in the high-temperature tank 39. Hence, if the high-temperature circulation fluid stored in the high-temperature tank 39 is less than required, it is possible to prevent the loss of time in the change of temperature, which is caused by feeding the circulation fluid that is low in temperature to the basic circulation path 22.

Moreover, the low-temperature path 31 and the high-temperature path 38 are provided with line junction pipes 35 and 40 and the branch line pipe 36 and a branch line pipe 41, which connect the plurality of circuit modules 21. Specifically, the low-temperature path 31 is provided on the inlet side with the line junction pipe 35 and on the outlet side with the branch line pipe 36. The high-temperature path 38 is provided on the inlet side with the line junction pipe 40 and on the outlet side with the branch line pipe 41.

Consequently, the plurality of circuit modules 21, for example, two to eight, or more circuit modules 21, can be connected to the low-temperature path 31 and the high-temperature path 38 via the line junction pipes 35 and 40 and the branch line pipes 36 and 41.

Each of the plurality of circuit modules 21 includes the circulating pump 25 and the heating apparatus 26, and can circulate the circulation fluid to another control target 46. Consequently, it is possible to cool or heat the control targets 46 in, for example, a plurality of spots to be processed or measured with high efficiency by use of one refrigeration cycle circuit 10 and adjust the control targets 46 to their suitable temperatures.

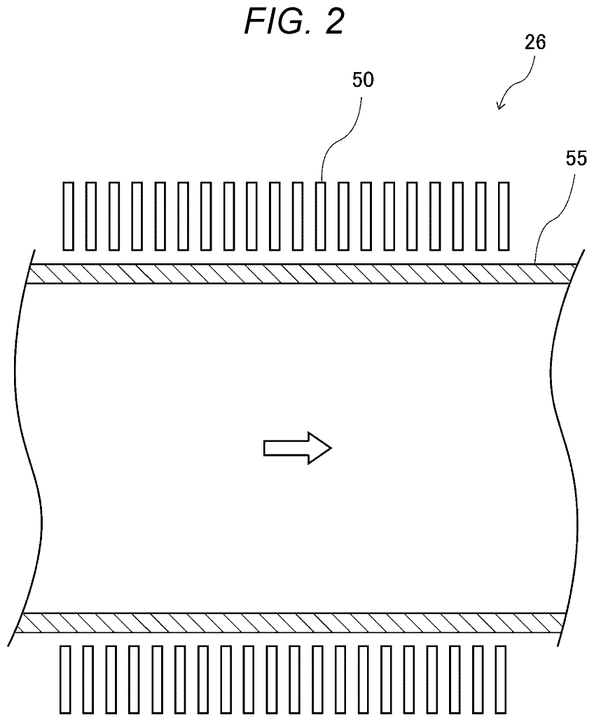

FIG. 2 is a diagram illustrating a schematic configuration of the heating apparatus 26, and illustrates the cross section of a pipe 55. Note that in FIG. 2, an arrow indicates the circulation fluid flow direction. The heating apparatus 26 includes the pipe 55 where the circulation fluid flows, and a primary coil 50 wound on an outer periphery of the pipe 55 (refer to FIG. 2)

The pipe 55 is provided to the feed path 23 (refer to FIG. 1) of the basic circulation path 22 (refer to FIG. 1), and serves as a channel where the circulation fluid flows.

The primary coil 50 generates an alternating magnetic field by use of an alternating current, is formed of, for example, a conductive wire covered with an insulating material, and is wound into an approximately spiral shape on the outer periphery of the pipe 55. In other words, the primary coil 50 configures a coil-shaped conductive path on the outer periphery of the pipe 55, and is connected at both ends to the induction heating power supply 48 (refer to FIG. 1).

The pipe 55 is formed of, for example, a conductive material. Consequently, the pipe 55 can generate heat by induction heating with the alternating current in the primary coil 50, and heat the circulation fluid flowing in the pipe 55.

In other words, a magnetic field is generated by the alternating current flowing through the primary coil 50. Eddy currents flow through the pipe 55 in such a manner as to cancel the magnetic field. The pipe 55 has electric resistance; therefore, the eddy currents flowing through the pipe 55 generates Joule heat. The circulation fluid flowing in the pipe 55 can be heated.

In this manner, the heat of the pipe 55 that generates heat by electromagnetic induction is transferred directly to the circulation fluid. Therefore, the circulation fluid can be efficiently heated to an exact temperature. Hence, it is possible for, for example, a semiconductor manufacturing apparatus to shorten the time required to heat the circulation fluid for temperature control and to execute a highly efficient processing process with little loss of time.

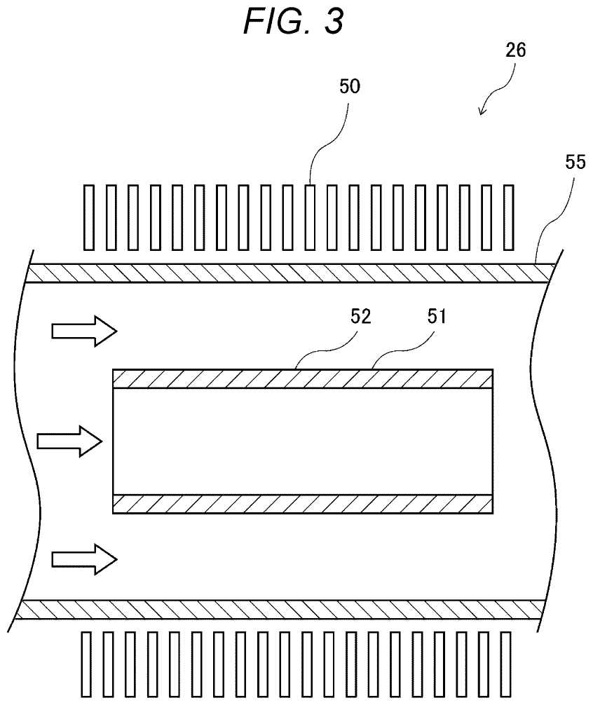

FIG. 3 is a diagram illustrating another example of the heating apparatus 26, and illustrates the cross section of the pipe 55. Note that in FIG. 3, an arrow indicates the circulation fluid flow direction. As illustrated in FIG. 3, the pipe 55 may be provided therein with a heating tube 52 as a heating element 51 made of a conductive material, inside an area where the primary coil 50 is wound.

For example, the heating tube 52 is an approximately tubular member provided substantially coaxially with the pipe 55. In other words, the pipe 55 and the approximately tubular heating tube 52 provided inside the pipe 55 form a substantially double-pipe shape. Such a heating tube 52 is provided; therefore, the heating tube 52 generates heat by induction heating with the alternating current in the primary coil 50, and as a result, the high-temperature heating tube 52 can heat the circulation fluid directly.

Note that the heating tube 52 provided inside the pipe 55 is simply required to be a member formed of a conductive material such as copper, iron, stainless steel, and other metals. It is preferable that the material forming the heating tube 52 be, for example, an iron-based material, a nickel alloy-based material, or a ferritic stainless steel material, whose relative inductivity is equal to or greater than one. Consequently, highly efficient induction heating is performed. Moreover, the shape of the heating tube 52 is not limited to a tubular shape.

Moreover, for example, a metal plate formed with through-holes as in, for example, punched metal may be used as the material forming the heating tube 52. Consequently, the holes formed in the heating tube 52 can be used as channels through which the circulation fluid passes. The heating tube 52 in such a form makes it possible to obtain the heating element 51 where the flow resistance of the circulation fluid is small and which can efficiently heat the circulation fluid.

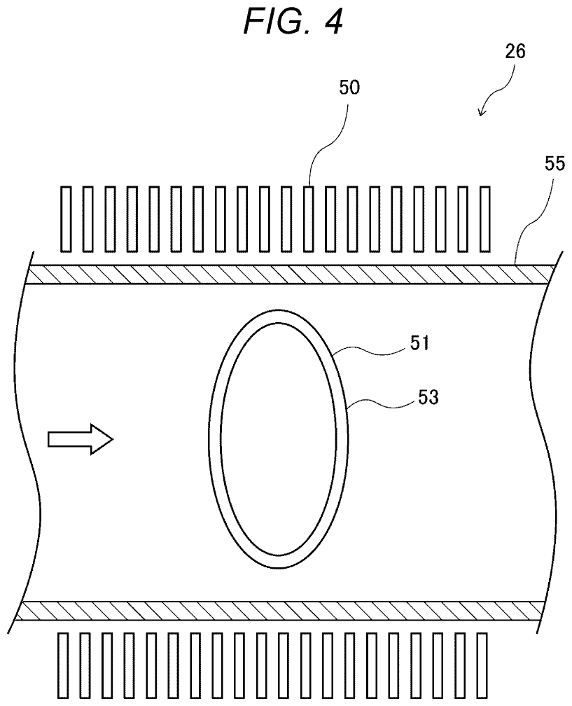

FIG. 4 is a diagram illustrating still another example of the heating apparatus 26, and illustrates the cross section of the pipe 55. Note that in FIG. 4, an arrow indicates the circulation fluid flow direction. As illustrated in FIG. 4, the heating element 51 provided inside the pipe 55 may be a heating loop 53 having a closed loop form formed of a conductive wire.

Specifically, both ends of the conductive wire forming the heating loop 53 are connected together in such a manner as to configure a conductive closed circuit. Such a form enables an induced current to efficiently flow through the heating element 51 and the efficiency of induction heating of the heating element 51 to increase. Moreover, it is possible to reduce the flow resistance of the circulation fluid near the heating element 51 and efficiently circulate the circulation fluid.

Moreover, the heating loop 53 may be formed of a conductive wire such as an iron wire, a nickel alloy wire, or a ferritic stainless steel wire, whose relative inductivity is equal to or greater than one. The use of a conductive wire made of such a ferromagnetic material enables concentration of magnetic flux to the heating element 51 and highly efficient induction heating. Moreover, the use of an iron wire can keep the manufacturing cost of the heating loop 53 low, and therefore, is suitable also from the perspective of the productivity of the heating loop 53.

Moreover, the conductive wire forming the heating loop 53 is covered with, for example, enamel, a glass tube, or a resin material. In other words, the conductive wire is coated or covered with, for example, a resin material. Consequently, leakage of an induced current to the outside of the conductive wire is prevented, and safe and highly efficient induction heating is performed.

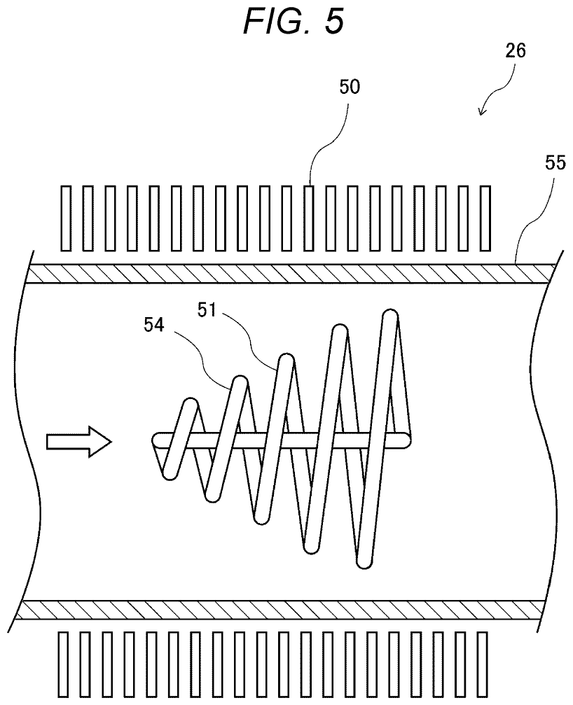

FIG. 5 is a diagram illustrating yet another example of the heating apparatus 26, and illustrates the cross section of the pipe 55. Note that in FIG. 5, an arrow indicates the circulation fluid flow direction. As illustrated in FIG. 5, a secondary coil 54 made of a conductive material may be provided as the heating element 51 inside the pipe 55. Specifically, the secondary coil 54 is a member being, for example, a conductive wire rod wound into a coil.

With such a configuration, the secondary coil 54 being the heating element 51 generates heat by induction heating with the alternating current in the primary coil 50. The heat of the secondary coil 54 that has reached a high temperature is transferred directly to the circulation fluid. The circulation fluid can be efficiently heated to an exact temperature. Hence, it is possible to reduce the loss of time in a manufacturing process and increase the productivity of, for example, a semiconductor apparatus.

Note that, the heating element 51 such as the heating tube 52 (refer to FIG. 3), the heating loop 53 (refer to FIG. 4), or the secondary coil 54 is fixed to an inner periphery of the pipe 55 with, for example, an unillustrated insulating support member. In other words, the heating element 51 such as the secondary coil 54 is not in contact with the primary coil 50 where the alternating current flows, and is provided in the pipe 55 where the circulation fluid flows. Hence, it is possible to reduce heat dissipation from, for example, the secondary coil 54 being the heating element 51 directly to the outside of the pipe 55, and perform highly efficient heating with little radiation heat loss.

Moreover, the heating apparatus 26 is configured in such a manner that the heating element 51 such as the secondary coil 54 is provided in a noncontact manner with the primary coil 50 to which the induction heating power supply 48 (refer to FIG. 1) is connected and to which an alternating current is supplied. Hence, it is excellent also from the perspective of safety and reliability against, for example, current leakage and damage to electric wiring.

Moreover, the heating element 51 wound into a coil is adopted in this manner; therefore, the flow resistance of the circulation fluid in the heating element 51 is reduced to enable highly efficient circulation of the circulation fluid.

Moreover, the secondary coil 54 as the heating element 51 configures a conductive closed circuit by connecting both ends of a coil path wound into a coil. Consequently, highly efficient induction heating where an induced current flows suitably is made possible.

Moreover, the secondary coil 54 may include a portion that is wound in such a manner that the winding diameter of the coil path is different between an upstream side and a downstream side of the pipe 55. Specifically, the secondary coil 54 may be formed with a large-diameter winding portion where the winding diameter of the coil path is large, and a small-diameter winding portion where the winding diameter of the coil path is small.

For example, the large-diameter winding portion and the small-diameter winding portion, which have different winding diameters, are formed in this manner. Therefore, it is possible to cause suitable turbulence in the circulation fluid around the secondary coil 54 and promote heat exchange between the heating element 51 and the circulation fluid. Hence, highly efficient heating with the secondary coil 54 allows the circulation fluid to be efficiently adjusted to an exact temperature in a short time.

Specifically, the secondary coil 54 may be wound into an approximately conical or approximately cup shape having a coil winding diameter that reduces gradually. Such a form prevents the circulation fluid flowing in the pipe 55 to pass through a position away from the secondary coil 54 as the heating element 51, and causes the circulation fluid to pass through the secondary coil 54 in proximity to a heating portion of the secondary coil 54.

In other words, the circulation water is prevented from passing through the secondary coil 54 while remaining at a low temperature without being heated by the secondary coil 54. The circulation fluid passing through the secondary coil 54 is suitably heated in proximity to the secondary coil 54. Hence, the secondary coil 54 can efficiently heat the circulation fluid to an exact temperature.

Note that as illustrated in FIG. 5, the secondary coil 54 wound into an approximately conical spiral shape may be provided in such a manner that the small-diameter winding portion whose winding diameter is small is on the upstream side of the flow of the circulation fluid and the large-diameter winding portion whose winding diameter is large is on the downstream side. Moreover, conversely, the secondary coil 54 may be provided in such a manner that the large-diameter winding portion whose winding diameter is large is on the upstream side of the pipe 55 and the small-diameter winding portion whose winding diameter is small is on the downstream side.

Moreover, as in the above-mentioned heating loop 53, the secondary coil 54 may be formed of a ferromagnetic material whose relative inductivity is equal to or greater than one, or preferably much greater than one. For example, the secondary coil 54 may be formed of at least one of, for example, a ferritic stainless steel material, an iron-based material, or a nickel alloy-based material.

The ferritic stainless steel material enables obtaining the secondary coil 54 excellent in corrosion resistance, durability, and safety, and increasing the efficiency of induction heating of the secondary coil 54 by concentrating an alternating magnetic field of the primary coil 50 to the secondary coil 54 made of a high magnetic material. Hence, the circulation fluid can be efficiently heated. Moreover, the iron-based material also has an advantage that the production cost of the secondary coil 54 can be reduced in addition to that an increase in the efficiency of induction heating can be encouraged. Moreover, the secondary coil 54 may be covered with an insulating member as in the above-mentioned heating loop 53.

Moreover, the pipe 55 may be formed of a non-magnetic material such as an austenitic stainless steel material. Consequently, it is possible to obtain the pipe 55 excellent in corrosion resistance, durability, and safety, and increase the efficiency of induction heating of the secondary coil 54 by concentrating an alternating magnetic field of the primary coil 50 to the secondary coil 54.

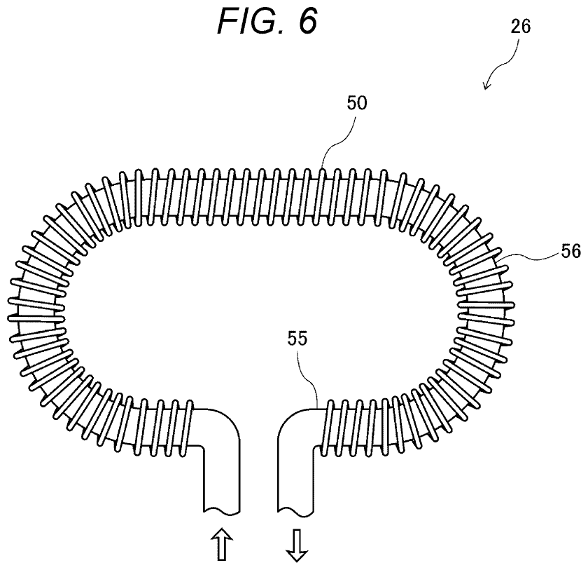

FIG. 6 is a diagram illustrating a schematic configuration of the heating apparatus 26, and illustrates an example of a schematic form of the pipe 55 and the primary coil 50. As illustrated in FIG. 6, the pipe 55 forming the heating apparatus 26 may include a bend pipe portion 56 in an area where the primary coil 50 is wound, and the area where the primary coil 50 is wound may be formed in an approximately circular shape, an approximately elliptic shape, or an approximately track shape. Consequently, it is possible to increase magnetic flux density in the pipe 55 by concentrating, in the pipe 55, magnetic flux generated by the alternating current in the primary coil 50.

In other words, the pipe 55 is formed with the bend pipe portion 56; therefore, one end of the area of the pipe 55 where the primary coil 50 is wound and the other end are close to each other. Consequently, magnetic flux generated outside the pipe 55 is generated at close range in such a manner that the vicinity of the one end and the vicinity of the other end, which are close to each other, are connected together. Hence, it is possible to reduce the magnetic flux along the outer periphery of the pipe 55 and concentrate the alternating magnetic flux in the pipe 55. It is possible to increase eddy currents generated in the heating element 51 such as the heating tube 52 (refer to FIG. 3), the heating loop 53 (refer to FIG. 4), or the secondary coil 54 (refer to FIG. 5) and increase the efficiency of induction heating.

FIG. 7 is a block diagram illustrating a control system of the temperature adjusting apparatus 1. As illustrated in FIG. 7, the temperature adjusting apparatus 1 includes the control device 43 that controls the constituent equipment. The control device 43 is a control means including a microprocessor, and executes a predetermined computation to control the temperature of the control target 46 (refer to FIG. 1).

Inputs of the control device 43 are connected to sensors such as the refrigerant temperature sensor 18 that detects the temperature of the refrigerant, the pressure sensor 19 that detects the pressure of the refrigerant, the temperature sensor 27 that detects the temperature of the circulation fluid to be supplied to the control target 46, the low-temperature sensor 37 that detects the temperature of the circulation fluid in the low-temperature path 31, the high-temperature sensor 42 that detects the temperature of the circulation fluid in the high-temperature path 38, and a temperature sensor 47 that detects the temperature of the control target 46.

Outputs of the control device 43 are connected to, for example, the compressor 11, the expansion valve 14, and the air-blowing fan 16 of the refrigeration cycle circuit 10, and the circulating pump 25, the heating apparatus 26, the solenoid valve 28, the three-way valve 29, the mixing valve 30, and the low-temperature pump 33 of the circulation fluid circuit 20.

Moreover, the control device 43 is provided with an input device 44 that inputs a temperature setting for the control target 46 and other pieces of operation information, and a display device 45 that displays information on the temperature of each portion and other pieces of control information.

Note that the control device 43 may be connected to, for example, other unillustrated sensors, information input equipment, display devices, control target equipment, and recording devices.

The control device 43 executes predetermined computations on the basis of inputs of, for example, the refrigerant temperature sensor 18, the pressure sensor 19, the temperature sensor 27, the low-temperature sensor 37, the high-temperature sensor 42, the temperature sensor 47, and the input device 44, and controls, for example, the compressor 11, the expansion valve 14, the air-blowing fan 16, the circulating pump 25, the heating apparatus 26, the solenoid valve 28, the three-way valve 29, the mixing valve 30, and the low-temperature pump 33.

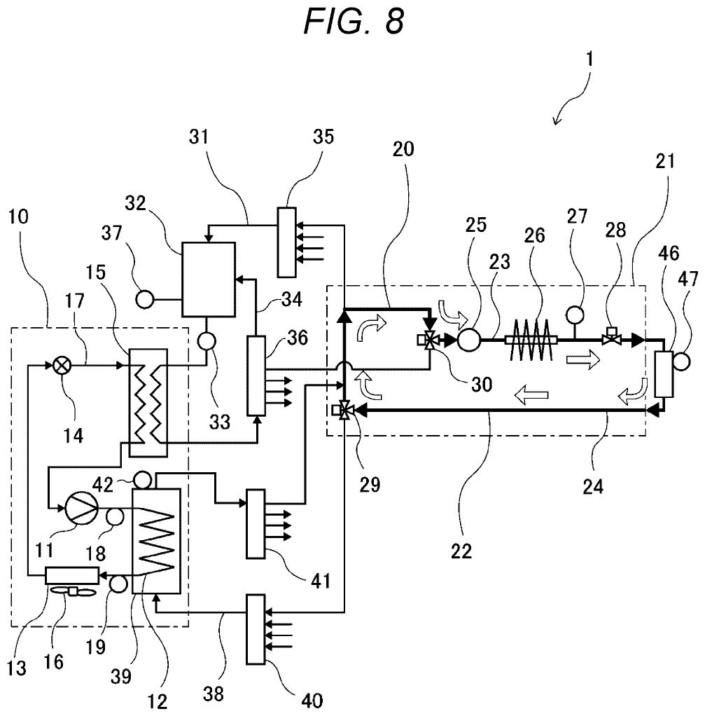

Next, a method for adjusting temperature with the temperature adjusting apparatus 1 is described in detail with reference to FIGS. 8 to 11.

FIG. 8 is a diagram illustrating a circulation fluid flow path, and illustrates an example where the circulation fluid cooled or heated in the refrigeration cycle circuit 10 is not used. Note that in FIGS. 8 to 11, the path where the circulation fluid flows is indicated by thick lines, and the circulation fluid flow direction is indicated by arrows.

As illustrated in FIG. 8, the three-way valve 29 closes the high-temperature path 38, and the mixing valve 30 closes the low-temperature path 31. Therefore, it is also possible to not supply, to the control target 46, the circulation fluid cooled by the evaporator 15 and the circulation fluid heated by the radiator 12. In other words, the circulation fluid circulates along the basic circulation path 22 without flowing along the low-temperature path 31 and the high-temperature path 38. In this manner, it is also possible to perform the temperature adjustment operation where the circulation fluid flowing along the low-temperature path 31 or the high-temperature path 38 is not fed to the feed path 23, but only the circulation fluid that has returned from the control target 46 is fed directly to the feed path 23, heated by the heating apparatus 26, fed to the control target 46, and circulated.

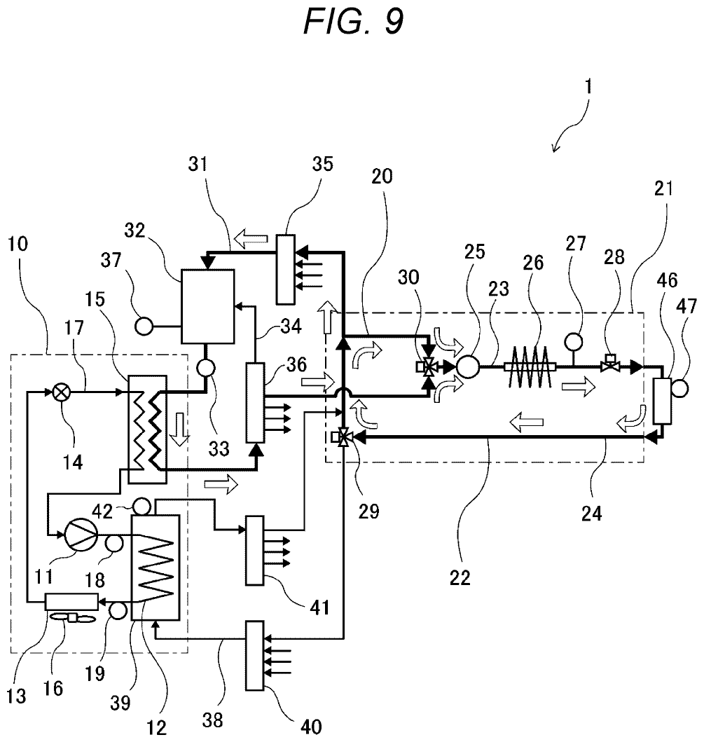

FIG. 9 is a diagram illustrating a circulation fluid flow path in a case where the temperature adjustment operation is performed by use of the circulation fluid cooled in the refrigeration cycle circuit 10. As illustrated in FIG. 9, if the control target 46 needs to be cooled, the control device 43 (refer to FIG. 7) controls the mixing valve 30, and opens the low-temperature path 31 of the circulation fluid circuit 20 to allow the circulation fluid to flow along the low-temperature path 31.

As a result, a part of the circulation fluid that has returned from the control target 46 flows along the low-temperature path 31, and is cooled by use of the latent heat of the refrigerant that evaporates in the evaporator 15 of the refrigeration cycle circuit 10. The circulation fluid cooled in the refrigeration cycle circuit 10 then merges with the circulation fluid in the basic circulation path 22 that has not flowed along the low-temperature path 31, is heated to a predetermined temperature by the heating apparatus 26, and is supplied at the suitable temperature to the control target 46 in such a manner that the control target 46 reaches a set temperature.

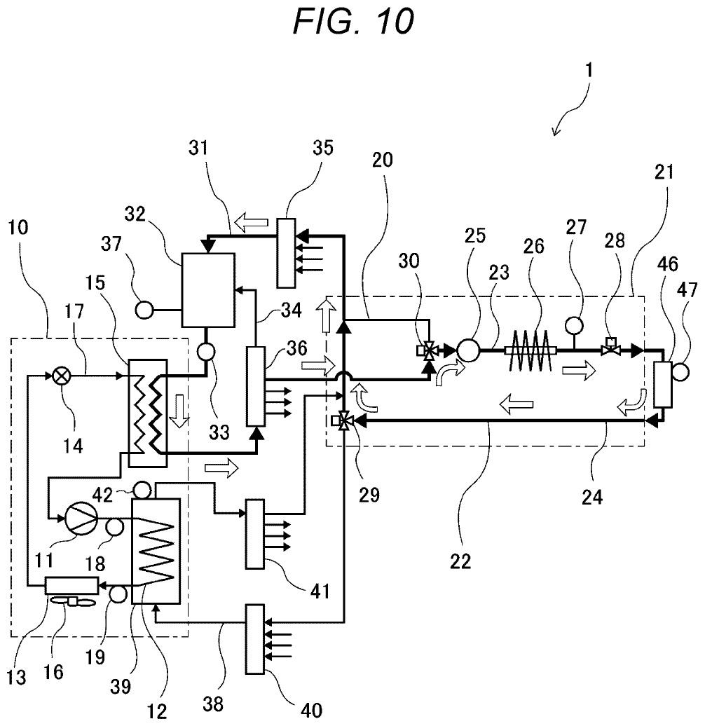

FIG. 10 is a diagram illustrating another example of using the circulation fluid cooled in the refrigeration cycle circuit 10. As illustrated in FIG. 10, the mixing valve 30 may be controlled in such a manner as to open the low-temperature path 31 100%. In other words, the circulation fluid returning from the control target 46 does not pass directly through the mixing valve 30, but all the circulation fluid returning from the control target 46 passes through the low-temperature path 31. Only the circulation fluid cooled by the refrigerant in the refrigeration cycle circuit 10 is then fed to the feed path 23 through the mixing valve 30.

With such a flow path, it is possible to feed, to the circulation fluid circuit 20, a large amount of circulation fluid cooled to a low temperature in the refrigeration cycle circuit 10 and stored in the low-temperature tank 32 and to quickly reduce the temperature of the circulation fluid to be supplied to the control target 46. Hence, it is possible to reduce the loss of time in, for example, the process of changing the temperature setting and increase productivity of, for example, a semiconductor apparatus.

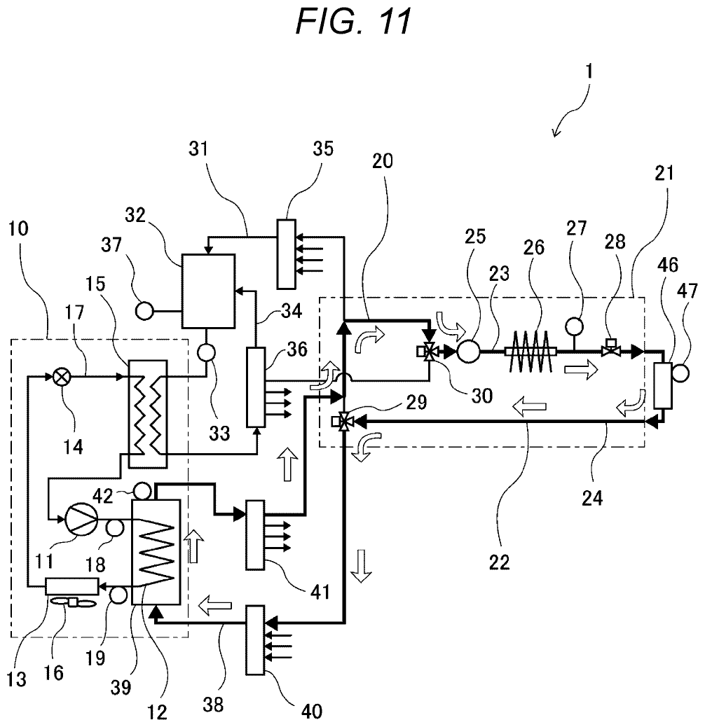

FIG. 11 is a diagram illustrating a circulation fluid flow path in a case where the temperature adjustment operation is performed by use of the circulation fluid heated in the refrigeration cycle circuit 10. If the temperature of the circulation fluid returning from the control target 46 is low and needs to be increased sharply, the control device 43 (refer to FIG. 7) controls the three-way valve 29 to open the high-temperature path 38 of the circulation fluid circuit 20. Consequently, the circulation fluid returning from the control target 46 flows along the high-temperature path 38. The circulation fluid in the high-temperature tank 39 that has increased to a high temperature by use of the heat dissipated from the refrigerant flowing through the radiator 12 of the refrigeration cycle circuit 10 is then fed to the basic circulation path 22 (refer to FIG. 11).

The circulation fluid heated in the refrigeration cycle circuit 10 is then fed to the feed path 23 via the mixing valve 30, heated to a predetermined temperature by the heating apparatus 26, and supplied at the suitable temperature to the control target 46 in such a manner that the control target 46 reaches an exact set temperature.

In this manner, the heat dissipation of the radiator 12 of the refrigeration cycle circuit 10 is used to heat the circulation fluid. The circulation fluid is stored in the high-temperature tank 39. The high-temperature circulation fluid stored in the high-temperature tank 39 is supplied to the basic circulation path 22. Therefore, the temperature of the circulation fluid flowing along the basic circulation path 22 can be changed to a high temperature in a short time. Hence, it is possible to keep the amount of energy consumed by the heating apparatus 26 of the circulation fluid circuit 20 low, and adjust temperature with high efficiency.

When the control device 43 opens the three-way valve 29, the high-temperature circulation fluid stored in the high-temperature tank 39 is fed to the basic circulation path 22. After the temperature of the circulation fluid circulating along the basic circulation path 22 increases to a predetermined temperature in a short time, the control device 43 may close the three-way valve 29 to perform normal temperature adjustment operation where the circulation fluid does not flow along the high-temperature path 38, as illustrated in FIGS. 8, 9, and 10.

In other words, as illustrated in FIG. 8, the operation that adjusts temperature may be performed by only the heating apparatus 26 heating the circulation fluid circulating along the basic circulation path 22 without using the refrigeration cycle circuit 10. Moreover, as illustrated in FIG. 9, the operation that adjusts temperature may be performed by mixing the low-temperature refrigerant flowing along the low-temperature path 31 with the circulation fluid circulating along the basic circulation path 22. Moreover, as illustrated in FIG. 10, the temperature adjustment operation may be performed in which the mixing valve 30 opens the low-temperature path 31 100%, and all the circulation fluid circulating along the basic circulation path 22 is fed to the feed path 23 via the low-temperature path 31.

In other words, as illustrated in FIG. 11, after the temperature is changed with a large temperature difference due to a change in, for example, a processing process, the temperature can be adjusted by use of cooling capacity and heating capacity as small as matching the amount of heat dissipated and the amount of heat absorbed from the control target 46, as illustrated in FIGS. 8, 9, and 10.

In this manner, the temperature adjusting apparatus 1 can change a temperature setting efficiently in a short time by circulating the circulation fluid along a suitable path according to the state of the control target 46, and can adjust the temperature of the control target 46 efficiently with a little amount of energy consumed.

As described above, the temperature adjusting apparatus 1 according to the embodiment can adjust the temperature of the control target 46 such as a semiconductor manufacturing apparatus with high efficiency and with little loss of exhaust heat by use of both cold heat and hot heat, which are generated in the refrigeration cycle circuit 10.

Note that the present invention is not limited to the above embodiment. The present invention can undergo various modifications and implementations within the scope that does not depart from the gist of the present invention.

### LIST OF REFERENCE NUMBERS

1 Temperature adjusting apparatus
10 Refrigeration cycle circuit
11 Compressor
12 Radiator
13 Second radiator
14 Expansion valve
15 Evaporator
16 Air-blowing fan
17 Refrigerant piping
18 Refrigerant temperature sensor
19 Pressure sensor
20 Circulation fluid circuit
21 Circuit module
22 Basic circulation path
23 Feed path
24 Return path
25 Circulating pump
26 Heating apparatus
27 Temperature sensor
28 Solenoid valve
29 Three-way valve
30 Mixing valve
31 Low-temperature path
32 Low-temperature tank
33 Low-temperature pump
34 Low-temperature circulation path
35 Line junction pipe
36 Branch line pipe
37 Low-temperature sensor
38 High-temperature path
39 High-temperature tank
40 Line junction pipe
41 Branch line pipe
42 High-temperature sensor
43 Control device
44 Input device
45 Display device
46 Control target
47 Temperature sensor
48 Induction heating power supply
50 Primacy coil
51 Heating element
52 Heating tube
53 Heating loop
54 Secondary coil
55 Pipe
56 Bend pipe portion

1-2. (canceled)

3. A heating apparatus that heats circulation fluid that adjusts a temperature of a control target, the heating apparatus comprising:
a pipe where the circulation fluid flows;
a primary coil wound on an outer periphery of the pipe, through which an alternating current flows; and
a conductive heating element provided inside an area of the pipe where the primary coil is wound, wherein
the heating element generates heat by induction heating with the alternating current in the primary coil, and the heating element heats the circulation fluid,
the heating element is formed of a conductive wire covered with an insulating member and having relative inductivity equal to or greater than one, and
the conductive wire is connected at both ends in such a manner as to configure a conductive closed loop.

4. A heating apparatus that heats circulation fluid that adjusts a temperature of a control target, the heating apparatus comprising:
a pipe where the circulation fluid flows;
a primary coil wound on an outer periphery of the pipe, through which an alternating current flows; and
a conductive heating element provided inside an area of the pipe where the primary coil is wound, wherein
the heating element generates heat by induction heating with the alternating current in the primary coil, and the heating element heats the circulation fluid,
the heating element is a secondary coil wound into a coil, and the secondary coil configures a conductive closed circuit by connecting both ends of a coil path wound into a coil.

5. The heating apparatus according to claim 4, wherein the secondary coil includes a portion that is wound in such a manner that a winding diameter of the coil path is different between an upstream side and a downstream side of the pipe.

6. The heating apparatus according to claim 4, wherein the secondary coil is formed of at least one of an iron-based material, a nickel alloy-based material, or a ferritic stainless steel material.

7. The heating apparatus according to claim 6, wherein the pipe is formed of an austenitic stainless steel material.

8. The heating apparatus according to claim 3, wherein
the pipe includes a bend pipe portion in the area where the primary coil is wound, and the area where the primary coil is wound is formed in a circular shape, an elliptic shape, or a track shape.

9-10. (canceled)

11. A temperature adjusting apparatus comprising:
a refrigeration cycle circuit where a compression means, a radiator, a throttle means, and an evaporator are sequentially connected and a refrigerant circulates; and
a circulation fluid circuit provided with a circulating pump and a heating apparatus, in which circulation fluid that adjusts a temperature of a control target circulates, wherein
the circulation fluid circuit is formed, upstream of the heating apparatus, with a freely openable and closable low-temperature path where the circulation fluid flows through the evaporator in such a manner that heat is exchangeable between the circulation fluid and the refrigerant,
the heating apparatus includes:
a pipe where the circulation fluid flows;
a primary coil wound on an outer periphery of the pipe, through which an alternating current flows; and
a conductive heating element provided inside an area of the pipe where the primary coil is wound,
the heating element generates heat by induction heating with the alternating current in the primary coil, and the heating element heats the circulation fluid,
the heating element is formed of a conductive wire covered with an insulating member and having relative inductivity equal to or greater than one, and
the conductive wire is connected at both ends in such a manner as to configure a conductive closed loop.

12. A temperature adjusting apparatus comprising:
a refrigeration cycle circuit where a compression means, a radiator, a throttle means, and an evaporator are sequentially connected and a refrigerant circulates; and
a circulation fluid circuit provided with a circulating pump and a heating apparatus, in which circulation fluid that adjusts a temperature of a control target circulates, wherein
the circulation fluid circuit is formed, upstream of the heating apparatus, with a freely openable and closable low-temperature path where the circulation fluid flows through the evaporator in such a manner that heat is exchangeable between the circulation fluid and the refrigerant,
the heating apparatus includes:
a pipe where the circulation fluid flows;
a primary coil wound on an outer periphery of the pipe, through which an alternating current flows; and
a conductive heating element provided inside an area of the pipe where the primary coil is wound,
the heating element generates heat by induction heating with the alternating current in the primary coil, and the heating element heats the circulation fluid,
the heating element is a secondary coil wound into a coil, and
the secondary coil configures a conductive closed circuit by connecting both ends of a coil path wound into a coil.

13. The temperature adjusting apparatus according to claim 12, wherein the secondary coil includes a portion that is wound in such a manner that a winding diameter of the coil path is different between an upstream side and a downstream side of the pipe.

14. The temperature adjusting apparatus according to claim 11, wherein
the pipe includes a bend pipe portion in the area where the primary coil is wound, and the area where the primary coil is wound is formed in a circular shape, an elliptic shape, or a track shape.

15. The temperature adjusting apparatus according to claim 11, wherein
the circulation fluid circuit is formed, upstream of the heating apparatus, with a freely openable and closable high-temperature path where the circulation fluid flows through the radiator in such a manner that heat is exchangeable between the circulation fluid and the refrigerant,
the refrigerant is carbon dioxide, and heats the circulation fluid under supercritical pressure in the radiator, and
the high-temperature path is provided with a high-temperature tank where the circulation fluid heated by the refrigerant in the radiator is stored.

16. The heating apparatus according to claim 4, wherein
the pipe includes a bend pipe portion in the area where the primary coil is wound, and the area where the primary coil is wound is formed in a circular shape, an elliptic shape, or a track shape.

17. The temperature adjusting apparatus according to claim 12, wherein
the pipe includes a bend pipe portion in the area where the primary coil is wound, and the area where the primary coil is wound is formed in a circular shape, an elliptic shape, or a track shape.

18. The temperature adjusting apparatus according to claim 12, wherein
the circulation fluid circuit is formed, upstream of the heating apparatus, with a freely openable and closable high-temperature path where the circulation fluid flows through the radiator in such a manner that heat is exchangeable between the circulation fluid and the refrigerant,
the refrigerant is carbon dioxide, and heats the circulation fluid under supercritical pressure in the radiator, and
the high-temperature path is provided with a high-temperature tank where the circulation fluid heated by the refrigerant in the radiator is stored.
